(19) United States
(12) Patent Application Publication
(10) Pub. No.: US 2023/0276724 A1
(43) Pub. Date: Sep. 7, 2023

(54) LAWN AERATOR APPARATUS

(71) Applicant: ECOLAWN AERATOR INCORPORATED, Chatham (CA)

(72) Inventor: Bruce AVERY, Chatham, ON (CA)

(73) Assignee: ECOLAWN AERATOR INCORPORATED, Chatham, ON (CA)

(21) Appl. No.: 18/023,994

(22) PCT Filed: Aug. 30, 2021
(86) PCT No.: PCT/CA2021/051199

§ 371 Date: Feb. 28, 2023

Related U.S. Application Data
(60) Provisional application No. 63/072,070, filed on Aug. 28, 2020.

(51) Int. Cl. A01B 45/02

(52) U.S. Cl. CPC A01B 45/026

(57) ABSTRACT

There is disclosed a lawn apparatus. In an embodiment, the lawn aerator apparatus, comprises: a plurality of lawn aerator mounting wheels configured to rotate independently, each lawn aerator mounting wheel having one of five or six tines mounted thereto; a lawn aerator chassis for mounting the plurality of lawn aerator wheels on a fixed structural shaft, each lawn aerator wheel having a sleeve with bearings; and a handle for operating the lawn aerator apparatus by turning the plurality of lawn aerator wheels about the fixed structural shaft.

### CROSS-REFERENCE TO RELATED APPLICATIONS

This application claims the benefit of U.S. Provisional Patent Application No. 63/072,070 filed on Aug. 28, 2020, which is incorporated by reference herein in its entirety.

### TECHNICAL FIELD

The present invention relates to a device for improving a ground Surface, and more particularly a lighter weight, passenger car transportable, manual pushed and electric motor and internal combustion engine power driven devices for aerating, fertilizing, dethatching, repairing, and otherwise improving the agricultural field or turf lawn surfaces.

### BACKGROUND

Lawn aerators are utilized to create holes into the surface soil of lawns to allow grass seed, air, and nutrients to enter beneath the surface, and for water to reach the roots. While larger, heavier commercial core plug lawn type aerators which are motorized and are generally effective, they are costly to operate and are not readily available for use by consumers. Conversely, some less capable lawn aerators available to consumers from local hardware stores and online platforms tend to have significant limitations in their performance and effectiveness, given their relatively light weight and conventional spike aerator type designs. What is therefore needed is an improved multi-purpose lawn aerator for use by consumers which addresses at least some of the limitations in the prior art.

### SUMMARY

As noted above, the present disclosure relates to an improved lawn aerator apparatus.

In an aspect, the lawn aerator apparatus comprises a plurality of independently rotating aerator wheels, each of the independently rotating aerator wheels having a plurality of tines.

In a preferred embodiment, each independently rotating aerator wheel has five or six tines, with each tine distributed evenly around the wheel at between 60 degrees and 72 degrees.

In another embodiment, the tines are adapted to be mounted to the independently rotating aerator wheel via fasteners, such as nuts and bolts.

In another embodiment, the radial mounting distance of the tines mounted on to the independently rotating aerator wheel may be adjusted by the consumer with additional mounting apertures in order to adjust the depth of penetration which accounts for the type and moisture content of lawn surfaces as well as the type, power, and curb weight of aeration equipment which the lawn aerator apparatus will be used by the consumer.

In another embodiment, each tine comprises a flat blade which, at its outermost point, is rounded to promote entry into and exit from a lawn surface as the tine rotates about a rotating shaft.

In another embodiment, each tine is formed from sheet metal which is bent alongside sections to form a shape which provides structural strength. Each bent side section is generally perpendicular to the flat blade, and provides a flared end nearest the outermost point of the flat blade which allows the tine to cut out a plug of soil. However, the perpendicular angle of the bent side sections allows the plug of soil to easily fall out of the tine, so that the tine remains clear of obstruction.

In another embodiment, as each lawn aerator wheel is independently mounted, each wheel is free to rotate as it engages the lawn. This allows the lawn aerator to travel over rougher terrain, uneven lawns, or obstacles such as tree roots while still being effective in pulling out core plugs of soil.

In another embodiment, lawn aerator wheels having five tines or six tines may be mixed on the same structural shaft to provide better coverage over random terrain and/or provide more or less plugs of soil per unit area or resist damaging the turf along the curved path of the lawn aerator when turning.

In another embodiment, a motor-assisted lawn aerator includes a manual or cordless electric drill which engages a gearing assembly to drive the wheels of the apparatus. An ergonomic handle which is easily adjustable in length in order to allow users of different heights to use the apparatus. The adjustability also allows the apparatus to be operated at different angles relative to the lawn for ease of use and also minimizes the overall size when the apparatus is being transported or stored. The ergonomic handle also has provisions for mounting and routing a plurality of electric motor cable controls for throttle and direction or other uses.

In another embodiment, the lawn aerator comprises a metal chassis which allows a plurality of lawn aerator wheels to be mounted at variable positions along a structural shaft which allows each of the lawn aerator wheels to rotate independently, and in opposite directions. This allows the lawn aerator to be very maneuverable around tight obstacles such as shrubs and gardens and also avoid tearing the turf along the curved path of the lawn aerator when turning. Additionally the center area of the structural shaft may also serve as a safe lifting point near the center of gravity of the apparatus for lifting, loading, and storing the lawn aerator.

In another embodiment, the metallic chassis may be configured to mount a weight, such as a user fillable liquid lawn or farm fertilizer tank or additional metal plates, to weigh down the lawn aerator with additional weight, thus allowing the tines to penetrate significantly deeper into the lawn soil.

In an embodiment, the weight is adjustable on the chassis module, such that the lawn aerator apparatus remains balanced regardless of the height of the consumer or as required by the motorized lawn equipment the consumer is driving, and the angle at which the apparatus is used.

In another embodiment, the towed lawn aerator with larger road wheels comprises a plurality of straight or bent frame members which may be varied in angle of bending from the longitudinal axis by angle A. The larger the bend angle will allow for significantly larger ground clearance heights when the aerator frame is flipped over in order for the aerator to be towed by the consumer's motorized lawn equipment over paved or uneven surfaces that do not require aeration to the lawn area requiring the apparatus. The adjustability of the bending angle during manufacturing also allows the apparatus to be safely towed without impacting obstacles along the path of towing while still allowing easy loading of the aerator chassis into trunks of light vehicles such as passenger automobiles according to the purchasing consumer's transportability and storage size requirements.

In another embodiment, the towed lawn aerator apparatus may have a plurality of additional towed lawn aerator apparatuses attached each with a plurality of modified tow frame members without the tongue weldment that may be quickly attached using fasteners such as locking pins to the main tow frame in order to allow for significantly wider areas to be aerated for every pass when towing the apparatus by the consumer's motorized lawn tractor. The adjustability of having additional towed lawn aerator apparatuses also allows the apparatus to be quickly and safely disassembled and stored into small vehicles such as passenger car trunks according to the consumer's transportability and storage size requirements.

In another embodiment, the cordless electric drill assisted lawn aerator comprises a single cordless electric drill mounted to a structural frame member and stiffener weldments that may be quickly attached using fasteners such as bolts and nuts to the manual push lawn aerator apparatus described above. The single cordless electric drill powered driven wheel assists the consumer to push or pull the apparatus along the lawn or field during aeration. The lawn aerator uses a single drive shaft connected to the driven wheel with a hub and fasteners such as nuts and bolts and the hexagonal end of the drive shaft is inserted and clamped by the keyless chuck of the cordless electric drill and tightened when using the apparatus. The cordless electric drill assisted lawn aerator offers significantly increased traction and mobility over hilly terrain and allows for very large surfaces to be aerated more quickly without significantly tiring the consumer. The cordless electric drill assisted lawn aerator comprises an ergonomic handle which has provisions for mounting and routing a plurality of electric motor cable controls for throttle and direction control or other uses such as controlling grass seed dispensing as well.

In another embodiment, the snow thrower pushed lawn aerator apparatus has a plurality of five and six tine aeration wheels rotating around a fixed structural shaft as well as a center stiffener member attached to center of the chassis structure using welding and to the structural shaft using fasteners such as nuts and bolts for increased stiffness and durability. The lawn aerator support frame has a plurality of structural frame members and support members that may be quickly attached using fasteners such as nuts and bolts to the main snow thrower frame near the gearbox. The plurality of structural frame members and support members can either stay mounted to the snow thrower chassis in all seasons or removed by the Consumer in the Winter Season depending on their needs. The lawn aerator has a single personal safety/dirt cover plate which is comprised of a bent metal plate that is matched to the exact size of the snow thrower inlet cowl structure and is secured with fasteners such as rivet-nuts and bolts to the snow thrower inlet cowl structure. The single personal safety/dirt cover plate's purposes are 1) to prevent any injury to the Consumer in the event that the shear pins were not removed from the snow thrower's first stage impellers and the engagement handle is activated during operation of the apparatus and 2) to prevent dirt, grit, and soil plugs from coating and corroding the snow handling mechanisms in the snow thrower inlet cowl and first, second, and third stage impellers as so equipped. The plurality of road wheels are mounted to a solid axle using fasteners such as cotter pins, nuts and bolts and in turn are mounted to a plurality of rotatable links which are mounted to the lawn aerator chassis with fasteners such as locking pins, nuts and bolts. The plurality of road wheels and plurality of links and the axle are pinned into to the aerator chassis in two positions with 1) the road wheels rotated to occupy two open spaces between the two outermost tine wheels on each side during lawn aeration and 2) tangent to the ground acting as road wheels when the apparatus is driven under its own power to the lawn area requiring the apparatus. This transportability allows for significantly larger areas to be aerated for every pass when pushing the apparatus by the consumer's motorized snow thrower which may now be used in multiple seasons. The motorized snow thrower pushed lawn aerator apparatus has the additional capability that allows the lawn aerator chassis and personal safety/dirt cover to be quickly and safely disassembled from the snow thrower in the winter season. The remaining plurality of permanent frame weldments that are mounted to the outside of the gear box frame and the outer structure of the impeller inlet cowl areas of the snow thrower in all seasons without compromising the performance and function of the snow thrower to any large extent. The lawn aerator chassis along with the plurality of side frame members and road wheels may be quickly removed and stored into small vehicles such as passenger car trunks according to the consumer's transportability and storage size requirements.

In this respect, before explaining at least one embodiment of the invention in detail, it is to be understood that the invention is not limited in its application to the details of construction and to the arrangements of the components set forth in the following description or the examples provided therein, or illustrated in the drawings. Therefore, it will be appreciated that a number of variants and modifications can be made without departing from the teachings of the disclosure as a whole. Therefore, the apparatus is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

The present apparatus will be better understood, and objects of the invention will become apparent, when consideration is given to the following detailed description thereof. Such description makes reference to the annexed drawings, wherein:

FIGS. 1A-1D show an aerator apparatus in accordance with an illustrative embodiment.

FIGS. 2A-2D show various detailed views of the aerator rotor shaft assembly in accordance with an embodiment;

FIG. 3 shows lawn repair tools mounted to the lawn aerator apparatus in accordance with an embodiment.

FIG. 4 shows a detailed front view of a six tine aerator plate in accordance with an embodiment;

FIGS. 5 shows a detailed front view of a six tine aerator plate with six tines in accordance with an embodiment;

FIGS. 6A and 6B show detailed front views of five and six tine aerator plates in accordance with various embodiments;

FIG. 7 shows a detailed front view of a five tine aerator plate with tines in accordance with an embodiment;

FIGS. 8A-8C show an aerator rotor shaft assembly from various views in accordance with an embodiment;

FIG. 9 shows a liquid fertilizer dispenser hose in accordance with an embodiment;

FIG. 10 shows illustrative additional features of the apparatus in accordance with an embodiment.

FIGS. 11A to 11D show various different views of a lawn aerator housing in accordance with an embodiment;

FIGS. 12A-12G show an illustrative aerator having a power assisted push feature in accordance with an illustrative embodiment;

FIGS. 13A to 13E show various views of a tow aerator in accordance with an illustrative embodiment;

FIGS. 14A and 14B show views of a tow aerator having a lift angle in accordance with an illustrative embodiment; and

FIGS. 15A to 15E show various views of a snow thrower aerator attachment in accordance with an illustrative embodiment.

### DETAILED DESCRIPTION

As noted above, the present disclosure relates to an improved lawn aerator apparatus.

In an aspect, the lawn aerator apparatus comprises a plurality of independently rotating aerator wheels, each of the independently rotating aerator wheels having a plurality of tines.

In a preferred embodiment, each independently rotating aerator wheel has five or six tines, with each tine distributed evenly around the wheel at between 60 degrees and 72 degrees.

In another embodiment, the tines are adapted to be mounted to the independently rotating aerator wheel via fasteners, such as nuts and bolts.

In another embodiment, the radial mounting distance of the tines mounted on to the independently rotating aerator wheel may be adjusted by the consumer with additional mounting apertures in order to adjust the depth of penetration which accounts for the type and moisture content of lawn surfaces as well as the type, power, and curb weight of aeration equipment which the lawn aerator apparatus will be used by the consumer.

In another embodiment, each tine comprises a flat blade which, at its outermost point, is rounded to promote entry into and exit from a lawn surface as the tine rotates about a rotating shaft.

In another embodiment, each tine is formed from sheet metal which is bent alongside sections to form a shape which provides structural strength. Each bent side section is generally perpendicular to the flat blade, and provides a flared end nearest the outermost point of the flat blade which allows the tine to cut out a plug of soil. However, the perpendicular angle of the bent side sections allows the plug of soil to easily fall out of the tine, so that the tine remains clear of obstruction.

In another embodiment, as each lawn aerator wheel is independently mounted, each wheel is free to rotate as it engages the lawn. This allows the lawn aerator to travel over rougher terrain, uneven lawns, or obstacles such as tree roots while still being effective in pulling out core plugs of soil.

In another embodiment, lawn aerator wheels having five tines or six tines may be mixed on the same structural shaft to provide better coverage over random terrain and/or provide more or less plugs of soil per unit area or resist damaging the turf along the curved path of the lawn aerator when turning.

In another embodiment, a motor-assisted lawn aerator includes a manual or cordless electric drill which engages a gearing assembly to drive the wheels of the apparatus. An ergonomic handle which is easily adjustable in length in order to allow users of different heights to use the apparatus. The adjustability also allows the apparatus to be operated at different angles relative to the lawn for ease of use and also minimizes the overall size when the apparatus is being transported or stored. The ergonomic handle also has provisions for mounting and routing a plurality of electric motor cable controls for throttle and direction or other uses.

In another embodiment, the lawn aerator comprises a metal chassis which allows a plurality of lawn aerator wheels to be mounted at variable positions along a structural shaft which allows each of the lawn aerator wheels to rotate independently, and in opposite directions. This allows the lawn aerator to be very manoeuvrable around tight obstacles such as shrubs and gardens and also avoid tearing the turf along the curved path of the lawn aerator when turning. Additionally the centre area of the structural shaft may also serve as a safe lifting point near the centre of gravity of the apparatus for lifting, loading, and storing the lawn aerator.

In another embodiment, the metallic chassis may be configured to mount a weight, such as a user fillable liquid lawn or farm fertilizer tank or additional metal plates, to weigh down the lawn aerator with additional weight, thus allowing the tines to penetrate significantly deeper into the lawn soil.

In an embodiment, the weight is adjustable on the chassis module, such that the lawn aerator apparatus remains balanced regardless of the height of the consumer or as required by the motorized lawn equipment the consumer is driving, and the angle at which the apparatus is used.

In another embodiment, the towed lawn aerator with larger road wheels comprises a plurality of straight or bent frame members which may be varied in angle of bending from the longitudinal axis by angle A. The larger the bend angle will allow for significantly larger ground clearance heights when the aerator frame is flipped over in order for the aerator to be towed by the consumer's motorized lawn equipment over paved or uneven surfaces that do not require aeration to the lawn area requiring the apparatus. The adjustability of the bending angle during manufacturing also allows the apparatus to be safely towed without impacting obstacles along the path of towing while still allowing easy loading of the aerator chassis into trunks of light vehicles such as passenger automobiles according to the purchasing consumer's transportability and storage size requirements.

In another embodiment, the towed lawn aerator apparatus may have a plurality of additional towed lawn aerator apparatuses attached each with a plurality of modified tow frame members without the tongue weldment that may be quickly attached using fasteners such as locking pins to the main tow frame in order to allow for significantly wider areas to be aerated for every pass when towing the apparatus by the consumer's motorized lawn tractor. The adjustability of having additional towed lawn aerator apparatuses also allows the apparatus to be quickly and safely disassembled and stored into small vehicles such as passenger car trunks according to the consumer's transportability and storage size requirements.

In another embodiment, the cordless electric drill assisted lawn aerator comprises a single cordless electric drill mounted to a structural frame member and stiffener weldments that may be quickly attached using fasteners such as bolts and nuts to the manual push lawn aerator apparatus described above. The single cordless electric drill powered driven wheel assists the consumer to push or pull the apparatus along the lawn or field during aeration. The lawn aerator uses a single drive shaft connected to the driven wheel with a hub and fasteners such as nuts and bolts and the hexagonal end of the drive shaft is inserted and clamped by the keyless chuck of the cordless electric drill and tightened when using the apparatus. The cordless electric drill assisted lawn aerator offers significantly increased traction and mobility over hilly terrain and allows for very large surfaces to be aerated more quickly without significantly tiring the consumer. The cordless electric drill assisted lawn aerator comprises an ergonomic handle which has provisions for mounting and routing a plurality of electric motor cable controls for throttle and direction control or other uses such as controlling grass seed dispensing as well.

In another embodiment, the snow thrower pushed lawn aerator apparatus has a plurality of five and six tine aeration wheels rotating around a fixed structural shaft as well as a centre stiffener member attached to centre of the chassis structure using welding and to the structural shaft using fasteners such as nuts and bolts for increased stiffness and durability. The lawn aerator support frame has a plurality of structural frame members and support members that may be quickly attached using fasteners such as nuts and bolts to the main snow thrower frame near the gearbox. The plurality of structural frame members and support members can either stay mounted to the snow thrower chassis in all seasons or removed by the Consumer in the Winter Season depending on their needs. The lawn aerator has a single personal safety/dirt cover plate which is comprised of a bent metal plate that is matched to the exact size of the snow thrower inlet cowl structure and is secured with fasteners such as rivet-nuts and bolts to the snow thrower inlet cowl structure. The single personal safety/dirt cover plate's purposes are 1) to prevent any injury to the Consumer in the event that the shear pins were not removed from the snow thrower's first stage impellers and the engagement handle is activated during operation of the apparatus and 2) to prevent dirt, grit, and soil plugs from coating and corroding the snow handling mechanisms in the snow thrower inlet cowl and first, second, and third stage impellers as so equipped. The plurality of road wheels are mounted to a solid axle and in turn to a plurality of rotatable links which are mounted to the lawn aerator chassis with fasteners such as cotter pins and locking pins. The plurality of road wheels and plurality of links and the axle are pinned into to the aerator chassis in two positions with 1) conveniently rotated to two open spaces between the two outer tine wheels during lawn aeration and 2) tangent to the ground acting as road wheels when the apparatus is driven under it's own power to the lawn area requiring the apparatus. This transportability allows for significantly larger areas to be aerated for every pass when pushing the apparatus by the consumer's motorized snow thrower which may now be used in multiple seasons. The motorized snow thrower pushed lawn aerator apparatus has the additional capability that allows the lawn aerator chassis and personal safety/dirt cover can be quickly and safely disassembled from the snow thrower in the winter season. The remaining plurality of permanent frame weldments that are mounted to the outside of the gear box frame and the outer structure of the impeller inlet cowl areas of the snow thrower in all seasons without compromising the performance and function of the snow thrower to any large extent. The lawn aerator chassis along with the plurality of side frame members and road wheels may be quickly removed and stored into small vehicles such as passenger car trunks according to the consumer's transportability and storage size requirements.

Various illustrative embodiments will now be disclosed with reference to the drawings.

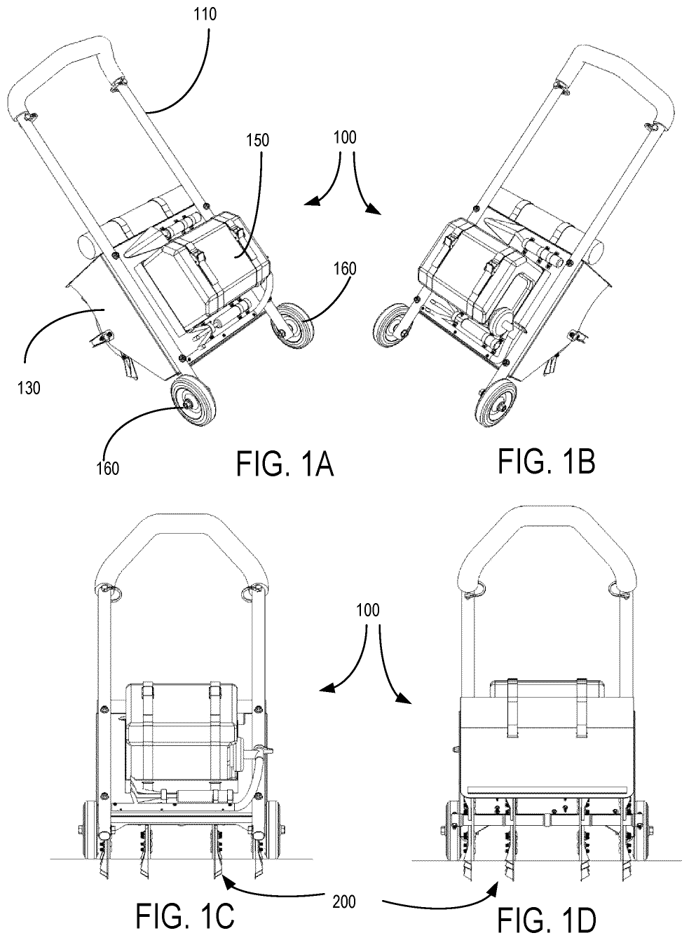

FIGS. 1A-1D show an aerator apparatus 100 in accordance with an illustrative embodiment. In this example, a push model is shown with a handle assembly 110 used to operate the apparatus 100. A housing 130 encloses an aerator rotor assembly 200, with tines penetrating the ground as shown in FIGS. 1C and 1D. A weighting tank or container 150 may be mounted above the housing to provide adequate weight for the tines to penetrate the ground. A pair of wheels 160 allows the apparatus 100 to be pushed by an operator as the tines penetrate the ground.

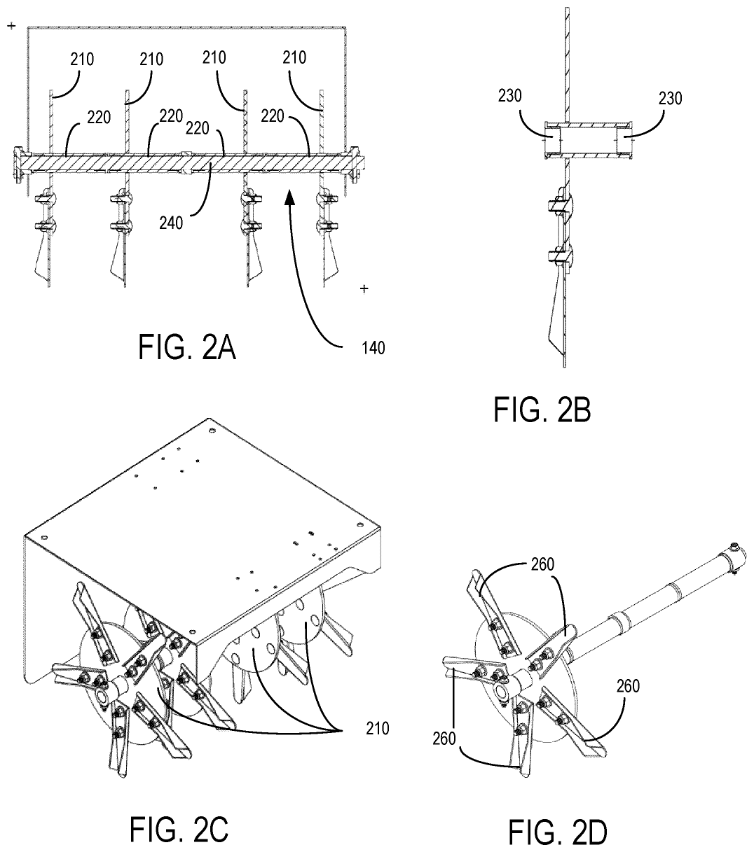

Now referring to FIGS. 2A-2D, shown are various detailed views of an aerator rotor shaft assembly 140 in accordance with an embodiment. A plurality of lawn aerator wheels 210 are shown with each wheel 210 welded to a tubular sleeve 220 with precision bearings 230 inserted at each end which are then mounted to a fixed structural shaft 240 to allow independent rotation and spacing relative to the other aerator wheels 210. As shown, the plurality of lawn aerator wheels 210 may also be mounted such that the opening of the tines 260 faces inwardly towards the center. Both five and six tine 260 lawn aerator wheels 210, as detailed further below, may be used at the same time, or the number of tines 260 may be matched across all wheels 210.

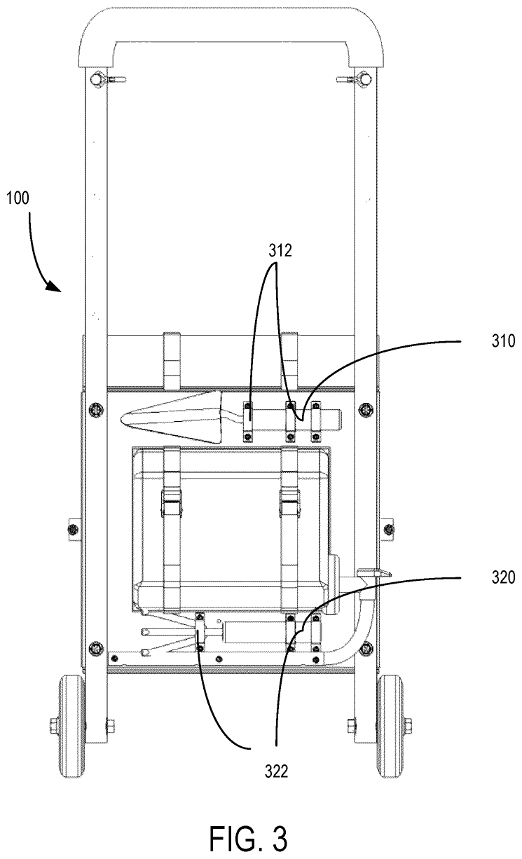

Now referring to FIG. 3, shown are illustrative lawn repair tools mounted to the lawn aerator apparatus 100. For example, a trowel 310 and garden claw 320 lawn repair tools may be mounted to the lawn aerator apparatus 100. A corresponding storage clamp 312, 322 may be provided for mounting the lawn repair tools 310, 320 on the lawn aerator 100. These mounted trowel 310 and garden claw 320 lawn repair tools allow the user to easily detach the tools from their storage clamps on the aerator frame and then use the garden claw 320 to manually remove excessive lawn thatch, rocks, sand, pet droppings, pet urine soaked or other chemically burned soil from damaged grass lawn areas to be repaired. The user then uses the garden trowel 310 to apply topsoil, grass seed, and saw dust or compost mixtures to the area which helps enable new grass to germinate and grow due to improved soil conditions and nutrients and would also require additional watering is provided by the rainy weather or watering by the user following the repair until new grass has been established.

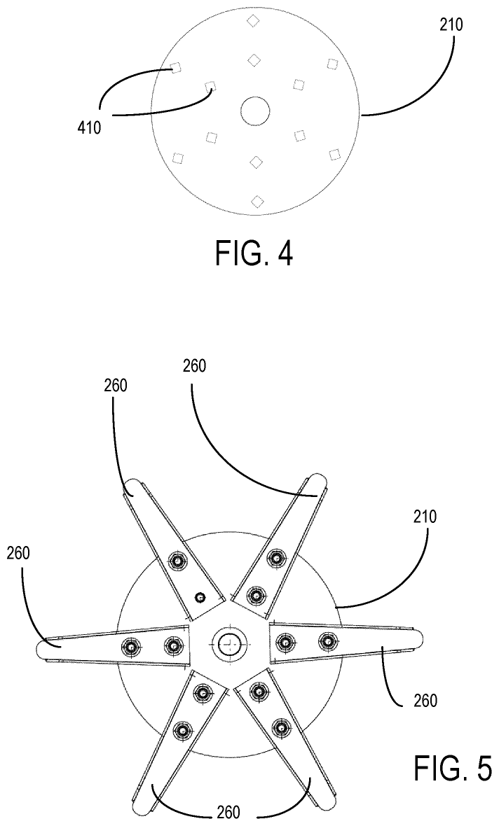

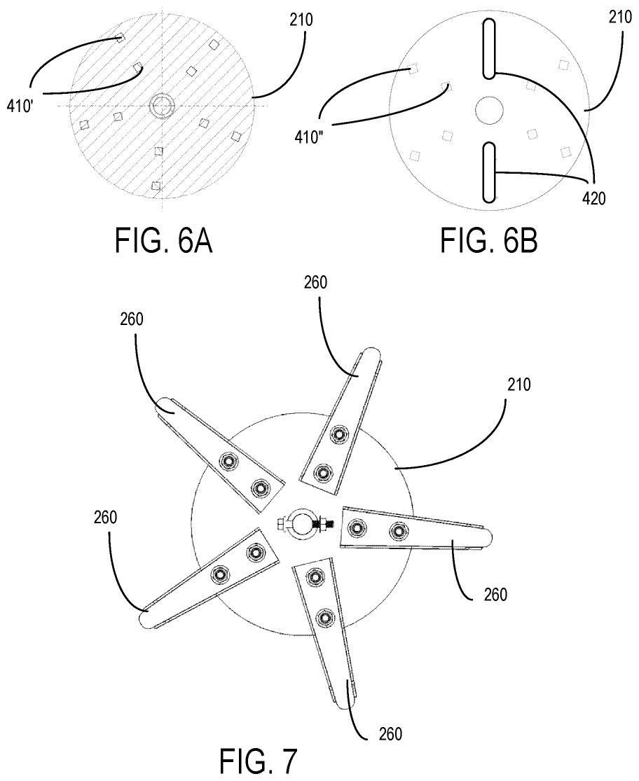

Now referring to FIG. 4, shown is a detailed front view of a six tine aerator plate 210 in accordance with an embodiment. In this configuration, the six tines 260 are separated by 60°. As shown in corresponding FIG. 5, each tine 260 is mounted to the corresponding lawn aerator wheel 210 using one or more fasteners, such as nuts and bolts for example. In an embodiment, the lawn aerator wheel 210 may be provided with additional apertures 410 such that the tines 260 may be mounted at different depths or distances relative to the center of the wheel or plate 210. In another embodiment, multiple sets of apertures 410 may be provided to mount the tines 260 at different depths or angles relative to each other.

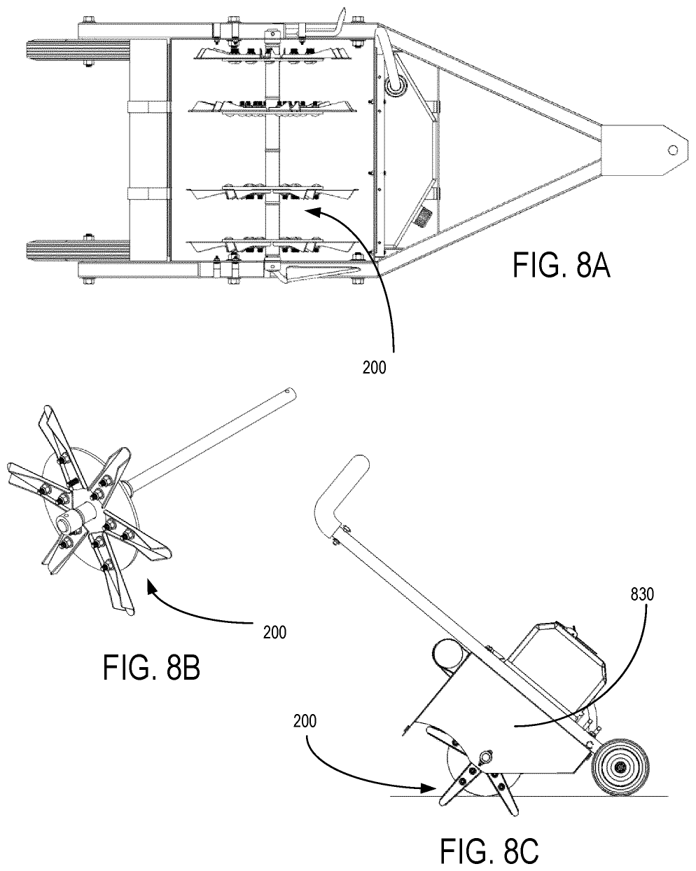

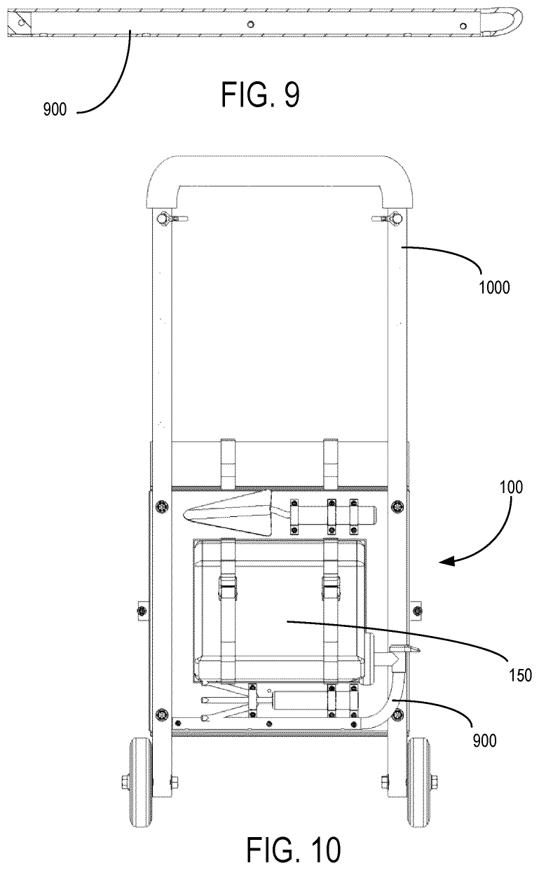

Now referring to FIGS. 6A and 6B, shown is a detailed front view of five and six tine aerator plates 210 in accordance with an embodiment. In the five tine configuration, the five tines 260 are separated by 72°. In another embodiment, the aperture shapes in the plates may be square 410′, a diamond 410″, or an elongated oval slot 420 radiating outwardly from the center of the wheel or plate 210, which allows continuous adjustment of the depth of each tine 260 relative to the center of the wheel or plate 210. As shown in FIG. 7, each tine 260 is mounted to a corresponding lawn aerator wheel 210 using one or more fasteners, such as nuts and bolts for example. Again, the lawn aerator wheel 210 may be provided with additional apertures such that the tines may be mounted at different depths or distances relative to the center of the wheel.

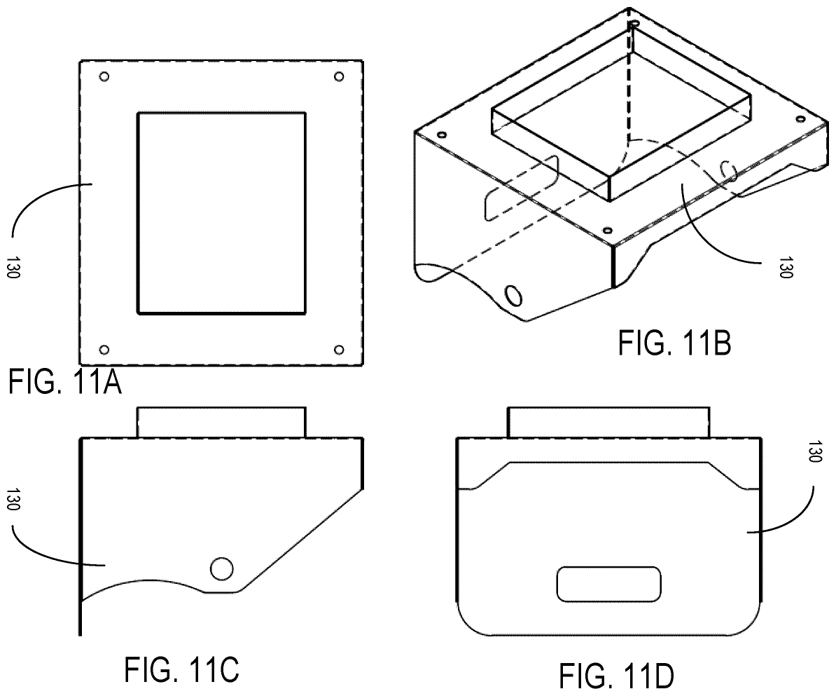

Now referring to FIGS. 8A-8C, shown is an aerator rotor shaft assembly 200 from various views on accordance with an embodiment. As shown, in this example, a total of four independently rotating aerator plates 210 mount six tines 260 each, and the aerator rotor shaft assembly 200 is mounted within another type of housing 830, as shown for example in FIG. 8C.

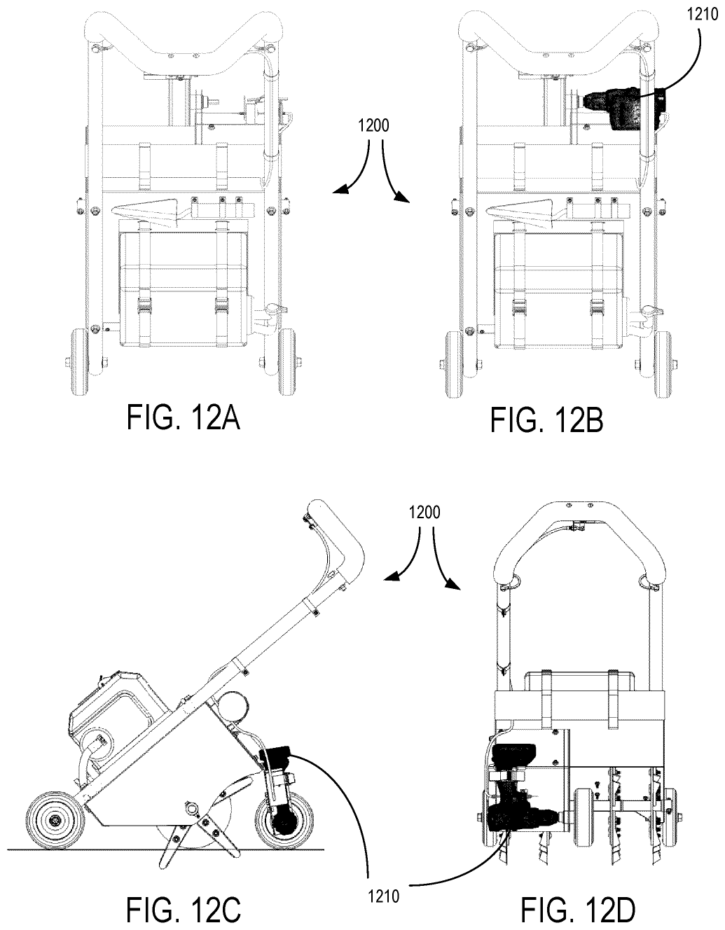

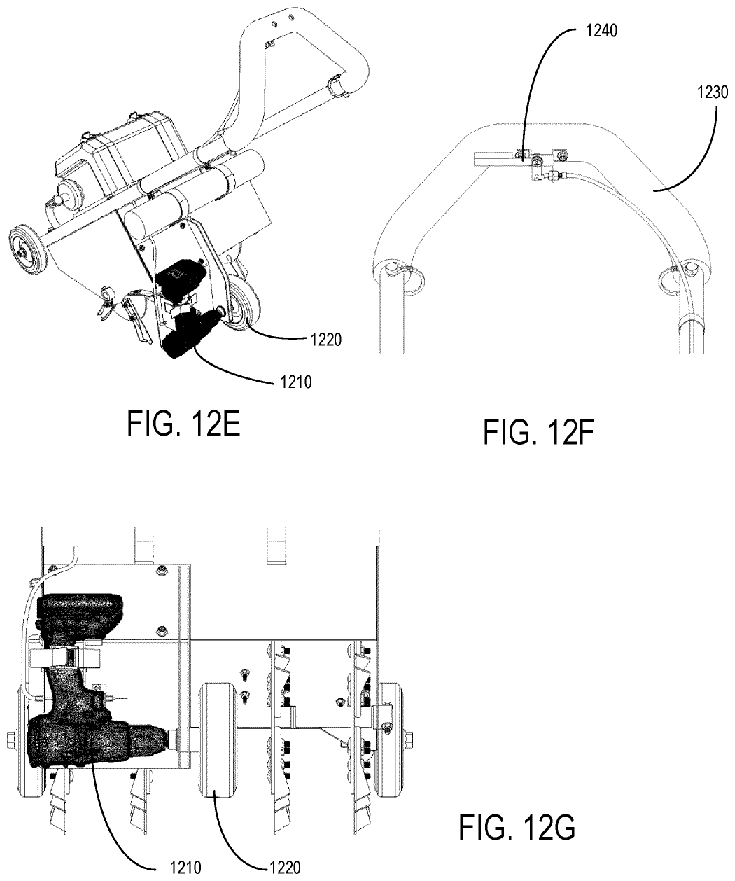

Now referring to FIG. 9, shown is an illustrative liquid fertilizer dispenser hose 900 which may be used to dispense liquid fertilizer as the lawn aerator is aerating the lawn. FIG. 10 shows the liquid fertilizer dispenser hose 900 on the apparatus 100 in accordance with an illustrative embodiment. This frame mounted liquid fertilizer dispenser 900 allows the user to open the spigot on the water tank 150 and spray liquid lawn fertilizer (water pre-mixed with concentrated liquid fertilizer) while performing lawn aeration. The applied drops of fertilizer will flow into the plug holes made by the aerator and soak into the roots and soil of the grass until fully absorbed which helps increase the health and growth rate of the grass on the lawn by providing essential nutrients such as nitrogen and iron if the user is using conventional type liquid fertilizers and also restore helpful soil bacteria if the user is using organic type liquid fertilizers.

Still referring to FIG. 10, an extendable handle frame 1000 assembly is shown in accordance with an embodiment. As shown, various parts of the handle frame 1000 are adjustable such that the lawn aerator apparatus is configured properly for the size and height of the person using the apparatus 100. In an embodiment, the overall length of the handle frame 1000 may be shortened or lengthened within a defined range to allow the user to push or pull the apparatus 100 with the highest efficiency and also ensure comfort and avoid injuries due to having advanced ergonomics dictate the tube bending angles for the embodiment.

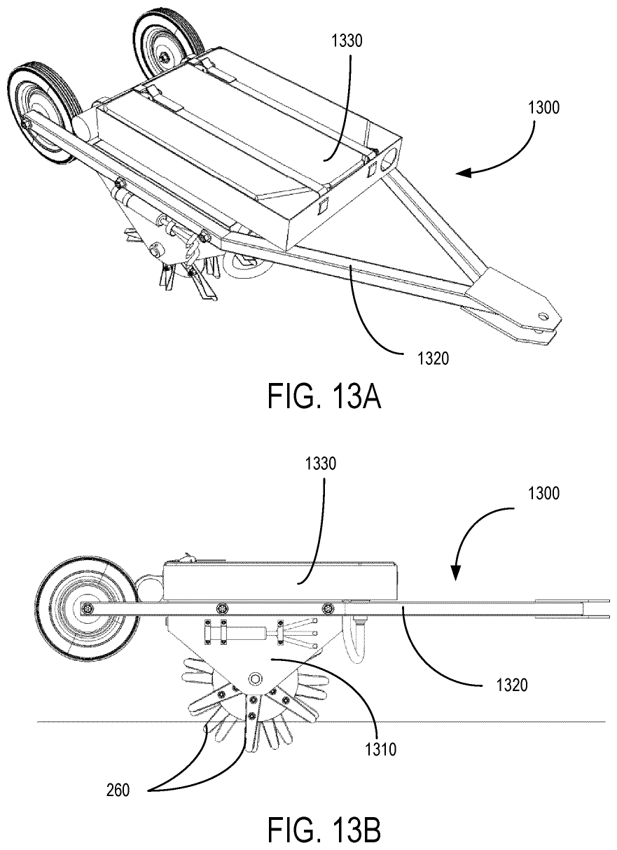

FIGS. 11A to 11D show various different views of a chassis 130 in accordance with an embodiment. In an embodiment, the lawn aerator housing is configured from sheet metal and tubular steel consisting of only four parts. The first two parts are shown on FIG. 11A to FIG. 11D which are plasma or laser cut from flat plates of sheet metal and then welded together for a cost-effective, structurally strong, safe, and light-weight assembly that provides the structural strength and integrity necessary for receiving the rotating shaft mounted thereto. In an embodiment, the chassis bushings are saw cut lengths of tubular metal which are then drilled at 90 degrees from their hole's axis for insertion of two shaft mounting bolts and then welded to the first two parts which makes the tine shaft part of the structure thereby drastically increasing the stiffness of the push lawn aerator housing or chassis against flexure and bending forces.

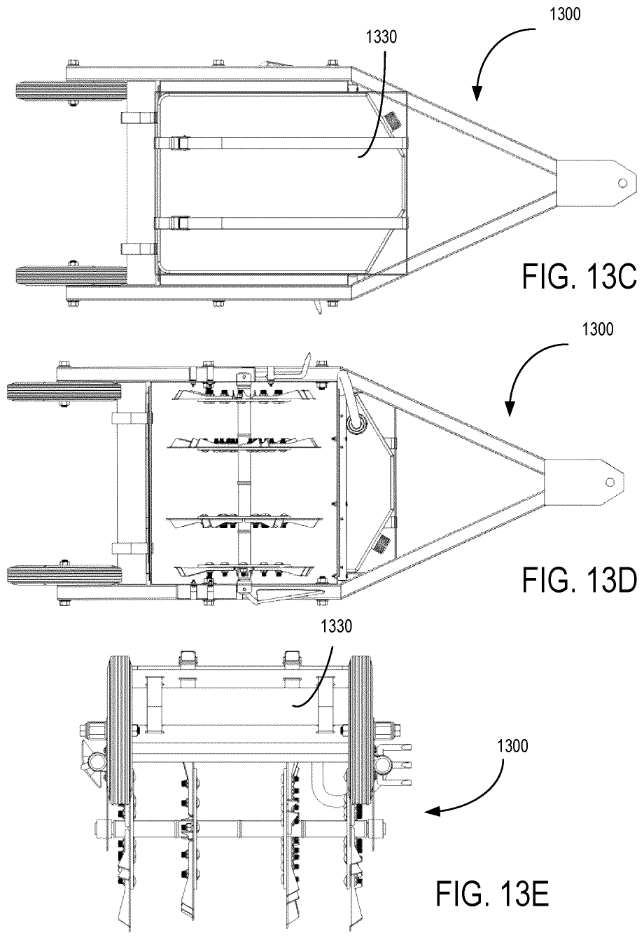

Now referring to FIGS. 12A-12G, shown is an illustrative aerator 1200 having a power assisted push feature in accordance with an illustrative embodiment. In an embodiment, the cordless electric drill assisted lawn aerator 1200 comprises a single cordless electric drill 1210 mounted to a structural frame member and stiffener weldments that may be quickly attached using fasteners such as bolts and nuts to the manual push lawn aerator apparatus described above. In an embodiment, the cordless electric drill 1210 drives a wheel 1220 to assist the consumer to push or pull the apparatus 1200 along the lawn or field during aeration. In this embodiment, the lawn aerator 1200 uses a single drive shaft connected to the driven wheel 1220 with a hub and fasteners such as nuts and bolts, and a hexagonal end of the drive shaft is inserted and clamped by a keyless chuck of the cordless electric drill 1210 and tightened when using the apparatus 1200. The cordless electric drill 1210 assisted lawn aerator 1200 offers significantly increased traction and mobility over hilly terrain and allows for very large surfaces to be aerated more quickly without significantly tiring the consumer. In an embodiment, the cordless electric drill 1210 assisted lawn aerator 1200 comprises an ergonomic handle 1230 which has provisions for mounting and routing a plurality of electric motor cable controls 1240 for throttle and direction control or other uses such as controlling grass seed dispensing as well.

By utilizing replaceable battery packs for the cordless drill 1210, the apparatus 1200 may continue to be power-assisted simply by swapping out a battery for the cordless electric drill as needed. The amount of assistance may be controlled, for example, by a control provided on the handle of the apparatus, as shown in detail in FIG. 12F.

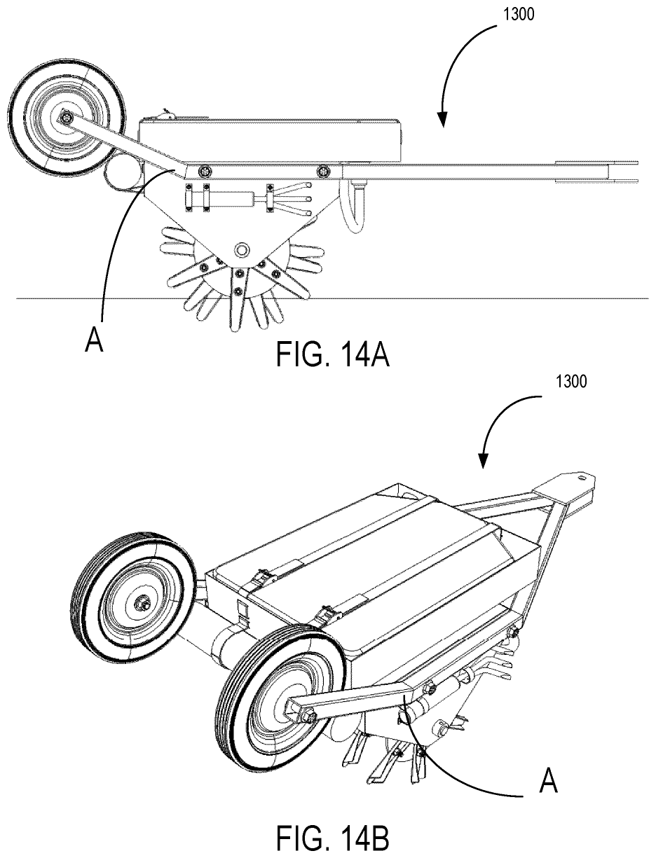

Now referring to FIGS. 13A to 13E, shown are various views of a tow aerator 1300 in accordance with an illustrative embodiment. In this embodiment, the lawn aerator may be configured as a towable model 1300 which may be towed for example by a lawn tractor with a suitable trailer harness. In an embodiment, a lawn aerator housing 1310 is mounted to a trailer frame 1320 at predrilled mounting points, the lawn aerator positions the tines 260 of the aerator at a suitable height. Various weighting features such as a liquid fertilizer tank 1330 or metal weights may be used to properly weigh the lawn aerator given the lawn conditions.

In another embodiment, the towed lawn aerator apparatus may have a plurality of additional towed lawn aerator apparatuses attached each with a plurality of modified tow frame members without the tongue weldment that may be quickly attached using fasteners such as locking pins to the main tow frame in order to allow for significantly wider areas to be aerated for every pass when towing the apparatus by the consumer's motorized lawn tractor. The adjustability of having additional towed lawn aerator apparatuses also allows the apparatus to be quickly and safely disassembled and stored into small vehicles such as passenger car trunks according to the consumer's transportability and storage size requirements.

In another embodiment, the trailer frame 1320 may also be flipped over with the tines facing upwards, so as to allow the lawn aerator to be pulled over hard road surfaces to get to a lawn surface.

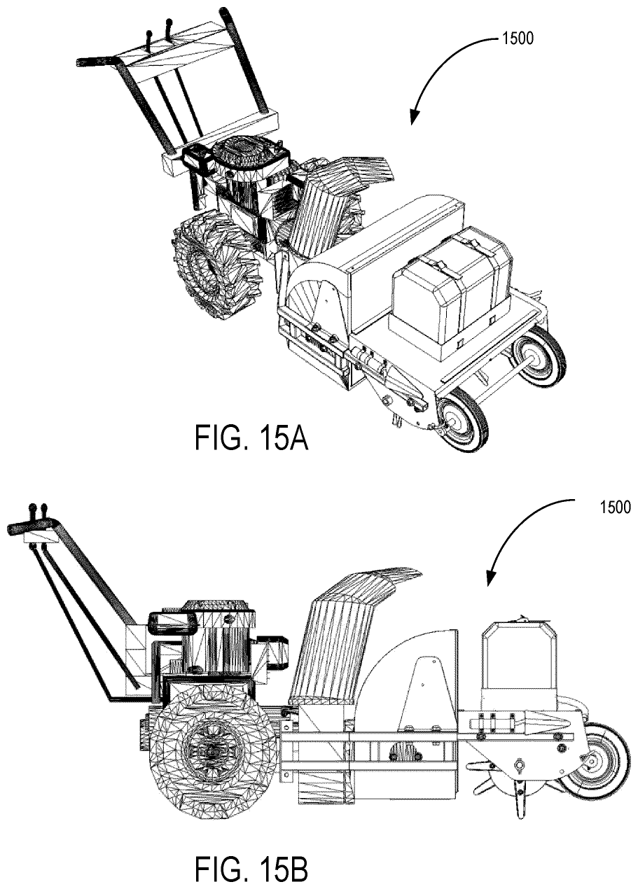

Now referring to FIGS. 14A and 14B, shown are views of a tow aerator having portion of the frame set at an angle A, in accordance with an illustrative embodiment. The towed lawn aerator with larger road wheels comprises a plurality of straight or bent frame members which may be varied in angle A of bending from the longitudinal axis. The larger the bend angle will allow for significantly larger ground clearance heights when the aerator frame 1320 is flipped over in order for the aerator to be towed by the consumer's motorized lawn equipment over paved or uneven surfaces that do not require aeration to the lawn area requiring the apparatus. The adjustability of the bending angle A during manufacturing also allows the apparatus to be safely towed without impacting obstacles along the path of towing while still allowing easy loading of the aerator chassis into trunks of light vehicles such as passenger automobiles according to the purchasing consumer's transportability and storage size requirements.

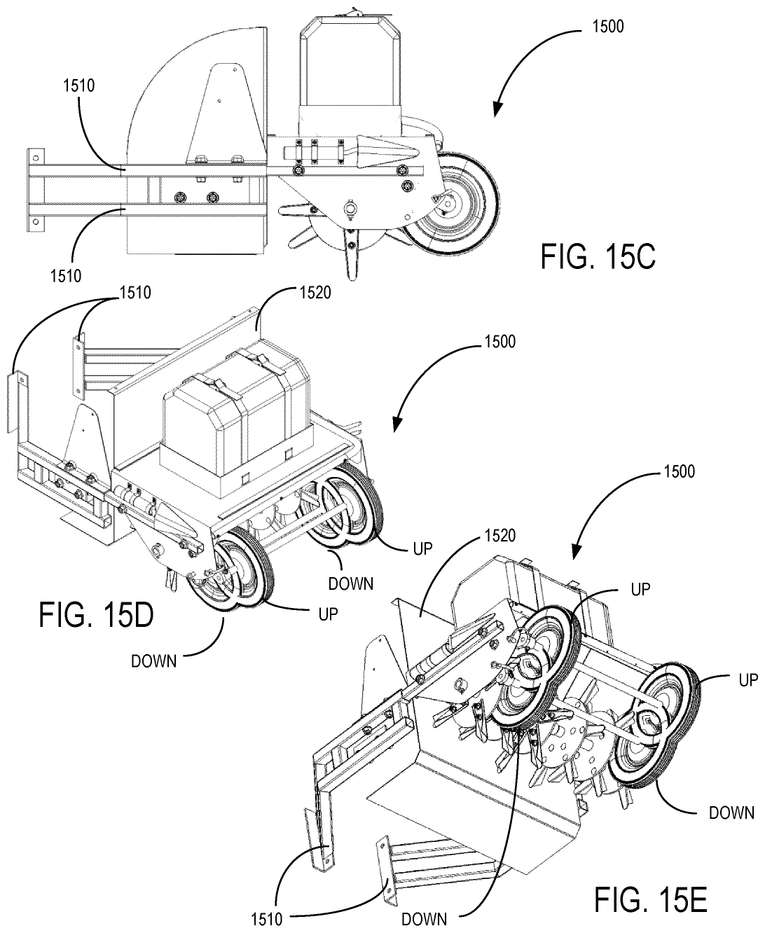

Now referring to FIGS. 15A to 15E, shown are various views of a snow thrower aerator attachment 1500 in accordance with an illustrative embodiment. In this example, the snow thrower pushed lawn aerator apparatus 1500 has a plurality of five and six tine aeration wheels rotating around a fixed structural shaft as well as a center stiffener member attached to center of the chassis structure using welding and to the structural shaft using fasteners such as nuts and bolts for increased stiffness and durability. The lawn aerator support frame 1510 has a plurality of structural frame members and support members that may be quickly attached using fasteners such as nuts and bolts to the main snow thrower frame near the gearbox. The plurality of structural frame members 1510 and support members can either stay mounted to the snow thrower chassis in all seasons or removed by the Consumer in the Winter Season depending on their needs. The lawn aerator 1500 has a single personal safety/dirt cover plate 1520 which is comprised of a bent metal plate that is matched to the exact size of the snow thrower inlet cowl structure and is secured with fasteners such as rivet-nuts and bolts to the snow thrower inlet cowl structure. The purposes of the single personal safety/dirt cover plate 1520 are 1) to prevent any injury to the Consumer in the event that the shear pins were not removed from the snow thrower's first stage impellers and the engagement handle is activated during operation of the apparatus and 2) to prevent dirt, grit, and soil plugs from coating and corroding the snow handling mechanisms in the snow thrower inlet cowl and first, second, and third stage impellers as so equipped. The plurality of road wheels are mounted to a solid axle using hardware such as cotter pins and in turn to a plurality of rotatable links which are mounted to the lawn aerator chassis with fasteners such as locking pins and nuts and bolts. The plurality of road wheels and plurality of links and the axle are pinned into to the aerator chassis in two positions with 1) the road wheels rotated to occupy the two open spaces between the two outermost tine wheels on each side during lawn aeration and 2) the road wheels tangent to the ground when the apparatus is driven under its own power to the lawn area requiring the apparatus. This transportability allows for significantly larger areas to be aerated for every pass when pushing the apparatus by the consumer's motorized snow thrower which may now be used in multiple seasons. The motorized snow thrower pushed lawn aerator apparatus has the additional capability that allows the lawn aerator chassis and personal safety/dirt cover to be quickly and safely disassembled from the snow thrower in the winter season. The remaining plurality of permanent frame weldments that are mounted to the outside of the gear box frame and the outer structure of the impeller inlet cowl areas of the snow thrower in all seasons without compromising the performance and function of the snow thrower to any large extent. The lawn aerator chassis along with the plurality of side frame members and road wheels may be quickly removed and stored into small vehicles such as passenger car trunks according to the consumer's transportability and storage size requirements.

Thus, in an aspect, there is provided a lawn aerator apparatus, comprising: a plurality of lawn aerator mounting wheels configured to rotate independently, each lawn aerator mounting wheel having one of five or six tines mounted thereto; a lawn aerator chassis for mounting the plurality of lawn aerator wheels on a fixed structural shaft, each lawn aerator wheel having a sleeve with bearings; and a frame for mounting the lawn aerator chassis and turning the plurality of lawn aerator wheels about the fixed structural shaft.

In an embodiment, the tines are independently mountable to each mounting wheel, such that each individual tine is replaceable.

In another embodiment, the height of each tine is adjustable on each mounting wheel.

In another embodiment, the tines comprise flat, curved blades at their tip, thereby allowing the tines to penetrate lawn surfaces.

In another embodiment, the tines further comprise side sections which flare towards the tips, such that the tines form channels for removing soil columns.

In another embodiment, the tines include an open side which allows soil to be easily removed to prevent blockage.

In another embodiment, the apparatus further comprises mounting points for lawn repair tools.

In another embodiment, the lawn repair tools comprise at least one of a trowel or a garden claw.

In another embodiment, the apparatus further comprises a liquid fertilizer dispenser mounted thereon.

In another embodiment, the apparatus further comprises a motor-assisted push drive.

In another embodiment, the motor-assisted push drive is provided by a cordless battery-powered drill engaging a gearing assembly operatively connected to at least one of the wheels on the apparatus.

In another embodiment, the apparatus further comprises the lawn aerator apparatus is configured as a trailer to be pulled.

In another embodiment, the lawn aerator apparatus trailer frame is configured to be flipped upside-down to be pulled over roads and hard surfaces.

In another embodiment, the lawn aerator apparatus trailer frame includes an angled section to allow greater clearance between the aerator chassis and the roads or hard surfaces when the lawn aerator apparatus is flipped upside-down.

In another embodiment, the apparatus is adapted to be attached to a snow thrower, and operated as an attachment to the snow thrower.

In another embodiment, the apparatus includes locking mounting brackets for mounting the apparatus to the snow thrower.

In another embodiment, the apparatus is adapted to be pushed forward by the snow thrower.

In another embodiment, the apparatus further comprises wheels adapted to lift the tines in a lowered position, and lower the tines in a raised position.

In another embodiment, the wheels are adapted to swing about a pivot point when lifted or lowered.

While illustrative embodiments have been described above by way of example, it will be appreciated that various changes and modifications may be made without departing from the scope of the invention, which is defined by the following claims.

1. A lawn aerator apparatus, comprising:
a plurality of lawn aerator mounting wheels configured to rotate independently, each lawn aerator mounting wheel having one of five or six tines mounted thereto;
a lawn aerator chassis for mounting the plurality of lawn aerator wheels on a fixed structural shaft, each lawn aerator wheel having a sleeve with bearings; and
a frame for mounting the lawn aerator chassis and turning the plurality of lawn aerator wheels about the fixed structural shaft.

2. The lawn aerator apparatus of claim 1, wherein the tines are independently mountable to each mounting wheel, such that each individual tine is replaceable.

3. The lawn aerator apparatus of claim 2, wherein the height of each tine is adjustable on each mounting wheel.

4. The lawn aerator apparatus of claim 1, wherein the tines comprise flat, curved blades at their tip, thereby allowing the tines to penetrate lawn surfaces.

5. The lawn aerator apparatus of claim 4, wherein the tines further comprise side sections which flare towards the tips, such that the tines form channels for removing soil columns.

6. The lawn aerator apparatus of claim 5, wherein the tines include an open side which allows soil to be easily removed to prevent blockage.

7. The lawn aerator apparatus of claim 1, further comprising mounting points for lawn repair tools.

8. The lawn aerator apparatus of claim 7, wherein the lawn repair tools comprise at least one of a trowel or a garden claw.

9. The lawn aerator apparatus of claim 1, further comprising a liquid fertilizer dispenser mounted thereon.

10. The lawn aerator apparatus of claim 1, further comprising a motor-assisted push drive.

11. The lawn aerator apparatus of claim 10, wherein the motor-assisted push drive is provided by a cordless battery-powered drill engaging a gearing assembly operatively connected to at least one of the wheels on the apparatus.

12. The lawn aerator apparatus of claim 1, wherein the lawn aerator apparatus is configured as a trailer to be pulled.

13. The lawn aerator apparatus of claim 12, wherein the lawn aerator apparatus trailer frame is configured to be flipped upside-down to be pulled over roads and hard surfaces.

14. The lawn aerator apparatus of claim 13, wherein the lawn aerator apparatus trailer frame includes an angled section to allow greater clearance between the aerator chassis and the roads or hard surfaces when the lawn aerator apparatus is flipped upside-down.

15. The lawn aerator apparatus of claim 1, wherein the apparatus is adapted to be attached to a snow thrower, and operated as an attachment to the snow thrower.

16. The lawn aerator apparatus of claim 15, wherein the apparatus includes locking mounting brackets for mounting the apparatus to the snow thrower.

17. The lawn aerator apparatus of claim 16, wherein the apparatus is adapted to be pushed forward by the snow thrower.

18. The lawn aerator apparatus of claim 15, further comprising wheels adapted to lift the tines in a lowered position, and lower the tines in a raised position.

19. The lawn aerator apparatus of claim 18, wherein the wheels are adapted to swing about a pivot point when lifted or lowered.
